(19) United States
(12) Patent Application Publication
(10) Pub. No.: US 2025/0164953 A1
(43) Pub. Date: May 22, 2025

(54) MACHINING SIMULATION DEVICE AND MACHINING SIMULATION METHOD

(71) Applicant: FANUC CORPORATION, Minamitsuru-gun, Yamanashi (JP)

(72) Inventors: Tarou OGISO, Yamanashi (JP); Tomonobu SUZUKI, Yamanashi (JP); Kojiro ARIMATSU, Yamanashi (JP)

(21) Appl. No.: 18/872,594

(22) PCT Filed: Apr. 7, 2023
(86) PCT No.: PCT/JP2023/014420

§ 371 Date: Dec. 6, 2024

(51) Int. Cl. G05B 17/02

(52) U.S. Cl. CPC G05B 17/02

(57) ABSTRACT

Provided is a machining simulation device comprising a friction model generation unit that generates a friction model of a machine tool and a simulation execution unit that uses the friction model to simulate and reproduce a behavior of the machine tool, wherein the friction model generation unit includes: a model determination unit that determines the type of the friction model according to the number pieces of data relating to a torque and a velocity; and a coefficient calculation unit that calculates a coefficient in the friction model on the basis of the determined type of the friction model and the number of pieces of data relating to the torque and the velocity and wherein the friction model generation unit reflects the generated friction model to the simulation execution unit.

### TECHNICAL FIELD

The present disclosure relates to a machining simulation device and a machining simulation method for generating a friction model of a machine tool using a machining simulation.

### BACKGROUND ART

For example, techniques for machining simulation devices are known, which allow a machine simulation unit to determine the transfer characteristics of a machine tool and estimate the tool position information, based on the position commands of a machining program and the transfer characteristics of the machine tool. See, for example, Patent Document 1.

Techniques for control devices are also known, which acquire at least the position command and position feedback for one or more axes of a machine, and based on the positional deviation that is the difference between the acquired position command and position feedback, estimate the coefficient of a friction model used in position control, and execute position control considering friction. See, for example, Patent Document 2.

Additionally, techniques are known, which generate a friction model by executing linear approximation using methods such as least-squares approximation on the frictional force and motor velocity acquired by controlling actual machines like XY tables or industrial robots, and using the frictional force obtained from the friction model as a compensation value to control the actual machine with high precision. See, for example, Patent Document 3.

### CITATION LIST

### Patent Document

Patent Document 1: Japanese Unexamined Patent Application, Publication No. 2019-152936
Patent Document 2: Japanese Unexamined Patent Application, Publication No. 2019-185742
Patent Document 3: Japanese Unexamined Patent Application, Publication No. 2006-146572

### DISCLOSURE OF THE INVENTION

### Problems to be Solved by the Invention

However, the technology disclosed in Patent Document 1 requires analyzing the operational data of the machine tool to generate a friction model when considering friction as part of the transfer characteristics of the machine tool configuring the machine simulation unit.

The technologies disclosed in Patent Documents 1 to 3 require specialized knowledge to generate the friction model, and in some cases, trial operations of the machine tool need to be executed solely for the purpose of generating the friction model.

Therefore, there is a demand for a method that allows for easily generating a friction model for a machine tool without requiring trial operations of the machine tool or specialized knowledge.

### Means for Solving the Problems

One aspect of the machining simulation device according to the present disclosure includes: a friction model generation unit configured to generate a friction model for a machine tool; and a simulation execution unit configured to simulate and reproduce behavior of the machine tool using the friction model. The friction model generation unit includes: a model determination unit configured to determine a type of the friction model, based on a number of data points for torque and velocity; and a coefficient calculation unit configured to calculate coefficients of the friction model, based on the determined type of the friction model and torque and velocity data for the number of data points. The friction model generation unit reflects the generated friction model in the simulation execution unit.

One aspect of the machining simulation method according to the present disclosure is a machining simulation method that causes a computer to function as a machining simulation device, in which the method includes: a friction model generating step of generating a friction model for a machine tool; and a simulation executing step of simulating and reproducing behavior of the machine tool using the friction model. The friction model generating step includes: a model determining step of determining a type of the friction model, based on a number of data points for torque and velocity; and a coefficient calculating step of calculating coefficients of the friction model, based on the determined type of friction model and the torque and velocity data for the number of data points. The friction model generating step reflects the generated friction model in the simulation executing step.

### BRIEF DESCRIPTION OF THE DRAWINGS

FIG. 1 is a diagram illustrating an example of the functional block configuration of the machining simulation system according to one embodiment;

FIG. 2A is a diagram illustrating an example of the relationship between the number of data points and the type of friction model;

FIG. 2B is a diagram illustrating an example of the relationship in FIG. 2A as represented in a graph;

FIG. 3A is a diagram illustrating an example of a screen in a case where the number of data points is one;

FIG. 3B is a diagram illustrating an example of a screen in a case where the number of data points is two (identical);

FIG. 3C is a diagram illustrating an example of a screen in a case where the number of data points is two (opposite);

FIG. 3D is a diagram illustrating an example of a screen in a case where the number of data points is four;

FIG. 3E is a diagram illustrating an example of a screen in a case where the number of data points is five; and

FIG. 4 is a flowchart illustrating the simulation processing of the machining simulation device.

### PREFERRED MODE FOR CARRYING OUT THE INVENTION

Hereinafter, a machining simulation system according to one embodiment will be described in detail with reference to the drawings.

### ONE EMBODIMENT

First, an overview of the present embodiment will be described. In the present embodiment, the type of friction model is determined based on the number of data points for torque and velocity, and the coefficients of the friction model are calculated based on the determined type of friction model and the torque and velocity data for the number of data points. The generated friction model is then reflected in the simulation execution unit.

Thus, according to the present embodiment, a friction model for a machine tool can be easily generated without requiring a trial operation of the machine tool or specialized knowledge.

The above is the outline of the present embodiment.

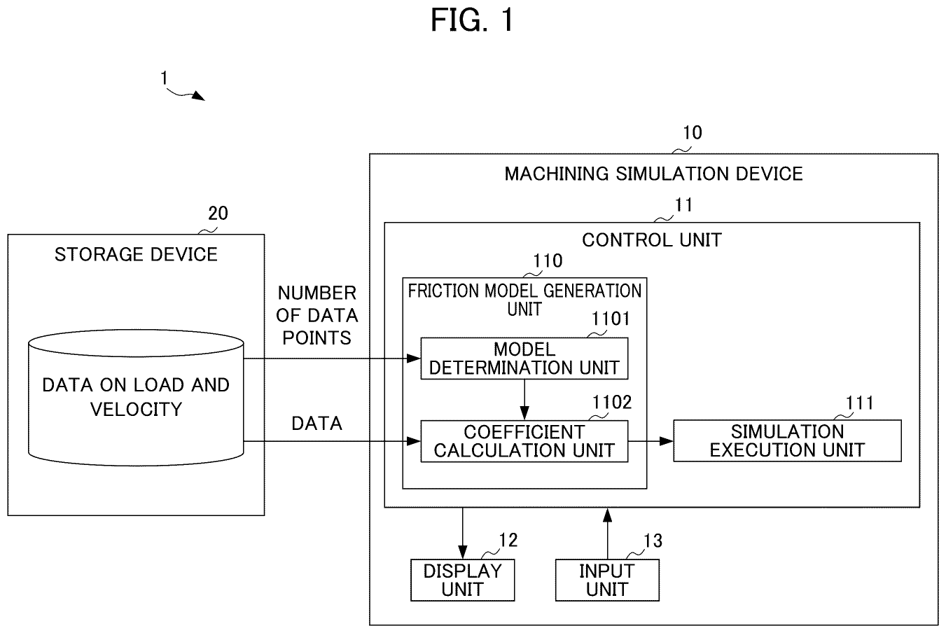

FIG. 1 is a diagram illustrating an example of the functional block configuration of the machining simulation system according to one embodiment.

As illustrated in FIG. 1, the machining simulation system 1 includes a machining simulation device 10 and a storage device 20.

The machining simulation device 10 and the storage device 20 are mutually connected via a network (not illustrated) such as a LAN (Local Area Network) or the internet to communicate with each other. In this case, the machining simulation device 10 and the storage device 20 include communication units (not illustrated) for mutual communication through such connections. The machining simulation device 10 and the storage device 20 may also be directly connected to each other through a connection interface (not illustrated).

Although the machining simulation device 10 and the storage device 20 are illustrated as separate devices, the storage device 20 may be included in the machining simulation device 10, as described later.

The storage device 20 is a data server or the like, and stores data on the load and velocity of motors included in the machine tool (not illustrated) as a simulation target. In the case where the machine tool (not illustrated) includes a plurality of motors, the storage device 20 may store the load and velocity data for each motor.

The load and velocity data refer to, for example, the data on the load torque applied to the motor or the load torque measured by a torque sensor, and the movement velocity of the feed shaft of the machine tool (not illustrated) as a control target (simulation target) when the velocity of the feed shaft is constant. In the case of a linear motor, the term torque is replaced with force.

### Machining Simulation Device 10

The machining simulation device 10 is a computer or the like well-known to those skilled in the art and includes a control unit 11, a display unit 12, and an input unit 13. The control unit 11 includes a friction model generation unit 110 and a simulation execution unit 111. The friction model generation unit 110 includes a model determination unit 1101 and a coefficient calculation unit 1102.

The display unit 12 is, for example, a liquid crystal display or the like. The display unit 12 displays screens related to the friction model generated by the friction model generation unit 110, as described later.

The input unit 13 is, for example, a keyboard or a touch panel arranged on the display unit 12, and receives input from the user.

### Control Unit 11

The control unit 11 includes a CPU (Central Processing Unit), ROM (Read-Only Memory), RAM (Random Access Memory), CMOS (Complementary Metal-Oxide-Semiconductor) memory, and the like, which are communicably connected with each other via a bus, as is well known to those skilled in the art.

The CPU is the processor that controls the entire machining simulation device 10. The CPU reads system programs and application programs stored in the ROM via the bus and controls the entire machining simulation device 10 in accordance with the system programs and application programs. Thus, as illustrated in FIG. 1, the control unit 11 is configured to implement the functions of the friction model generation unit 110 and the simulation execution unit 111. The friction model generation unit 110 is configured to implement the functions of the model determination unit 1101 and the coefficient calculation unit 1102. The RAM stores various data such as temporary calculation data and display data. The CMOS memory is backed up by a battery (not illustrated) and serves as non-volatile memory that retains the storage state even when the power to the machining simulation device 10 is turned off.

The friction model generation unit 110, for example, acquires data on the load and velocity, which represent the load (torque) values when the velocity of the feed shaft of the machine tool (not illustrated) is constant, from the storage device 20. The friction model generation unit 110 generates a friction model of the machine tool (not illustrated), based on the processing of the model determination unit 1101 and the coefficient calculation unit 1102 in accordance with the acquired data on the load and velocity and the number of data points, and reflects the generated friction model in the simulation execution unit 111.

The model determination unit 1101 determines the type of friction model, for example, based on the number of data points for load and velocity data of the machine tool (not illustrated) acquired from the storage device 20.

In order to describe the processing of the model determination unit 1101, the relationship between the number of data points and the type of friction model will be first described.

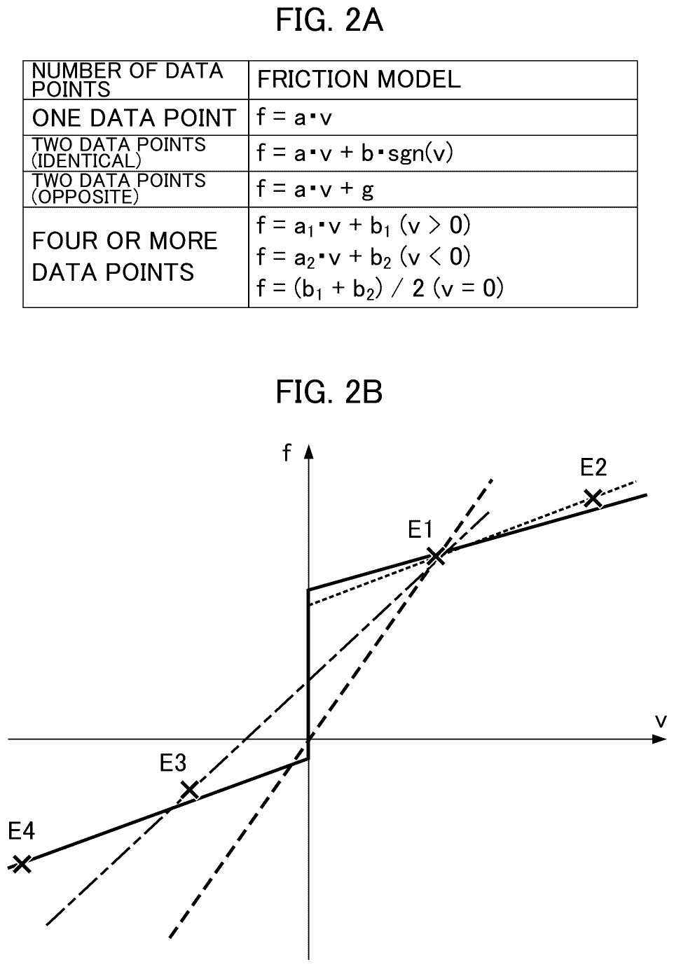

FIG. 2A is a diagram illustrating an example of the relationship between the number of data points and the type of friction model. FIG. 2B is a diagram illustrating an example of the relationship in FIG. 2A as represented in a graph.

As illustrated in FIG. 2A, the friction model is a function that outputs the load f using the velocity v as an input variable. As the number of data points increases, the function becomes more complex, and the accuracy of reproducing friction improves. That is, as illustrated in FIG. 2B, in the case where the number of data points for load and velocity data acquired from the storage device 20 is one (for example, load and velocity data E1), the friction model is a linear function with the coefficient a, represented by a dashed line, which corresponds to the type of viscous friction only. The load f output by the friction model is the “frictional force” in a linear system, and the “friction torque” in a rotational system.

In the case where the number of data points for load and velocity data acquired from the storage device 20 is two (identical), such as load and velocity data E1 and E2, for example, where the moving directions of the feed shaft of the machine tool (not illustrated) are the same, the friction model becomes a linear function with the coefficient a and the intercept b·sgn(v) passing through the two data points as indicated by the dotted line. This model corresponds to the type combining viscous friction and static friction. The sign function sgn(v) is 1 when the velocity v is positive and −1 when the velocity v is negative. In other words, static friction has a sign that depends on the moving direction, and a magnitude that does not depend on velocity. In the case where the number of data points is two (identical), the friction model may be adjusted to ensure continuity near velocity v=0 to stabilize calculations.

In the case where the number of data points for load and velocity data acquired from the storage device 20 is two (opposite), such as load and velocity data E1 and E3, for example, where the moving directions of the feed shaft of the machine tool (not illustrated) are opposite, the friction model becomes a linear function with the coefficient a and the intercept g passing through the two data points as indicated by the chain line. This model is a type combining viscous friction and a constant effect. The intercept g is a constant effect in a specific direction, which is gravity.

In the case where the number of data points for load and velocity data acquired from the storage device 20 is four or more (for example, load and velocity data E1 to E4), where the moving directions of the feed shaft of the machine tool (not illustrated) are both positive and negative each including two or more data points, the friction model becomes a model with the velocity v as indicated by the solid line, with the load f=a₁·v+b₁ on the positive side, the load f=a₂·v+b₂ on the negative side, and the load f=(b₁+b₂)/2 at the velocity v being “0”. This model is a type combining viscous friction, static friction, and a constant effect.

As described above, the model determination unit 1101 determines the type of friction model, based on the number of data points for load and velocity data acquired from the storage device 20 (based on the relationship between the moving directions of the feed shaft of the machine tool (not illustrated) between the two data points in the case where the number of data points is two).

The coefficient calculation unit 1102 calculates the coefficient a, the intercept b·sgn(v), and the intercept g in the friction model, based on the load and velocity data acquired from the storage device 20 and the determined type of friction model.

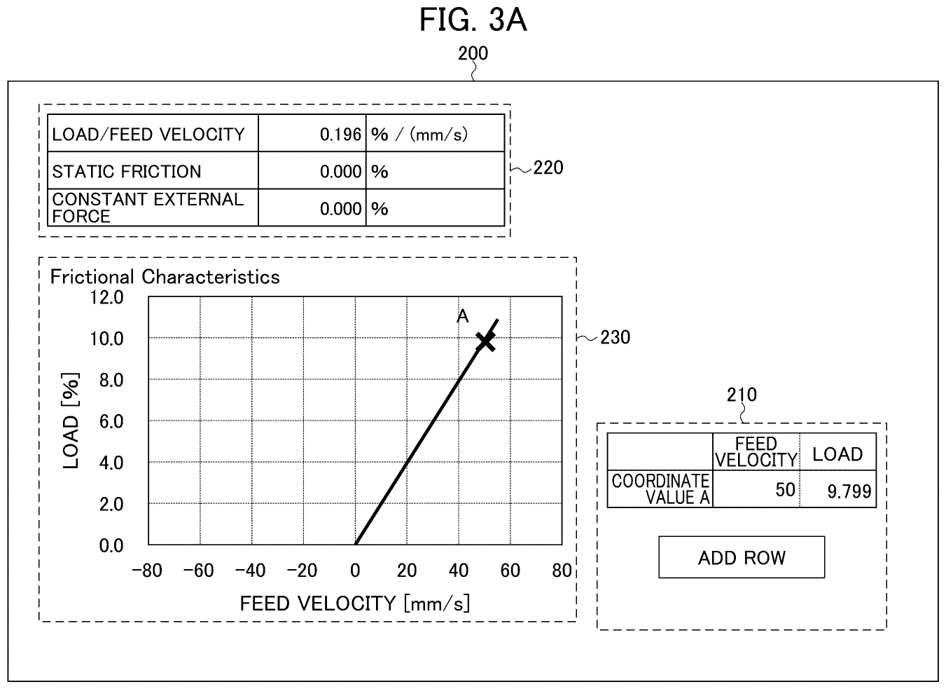

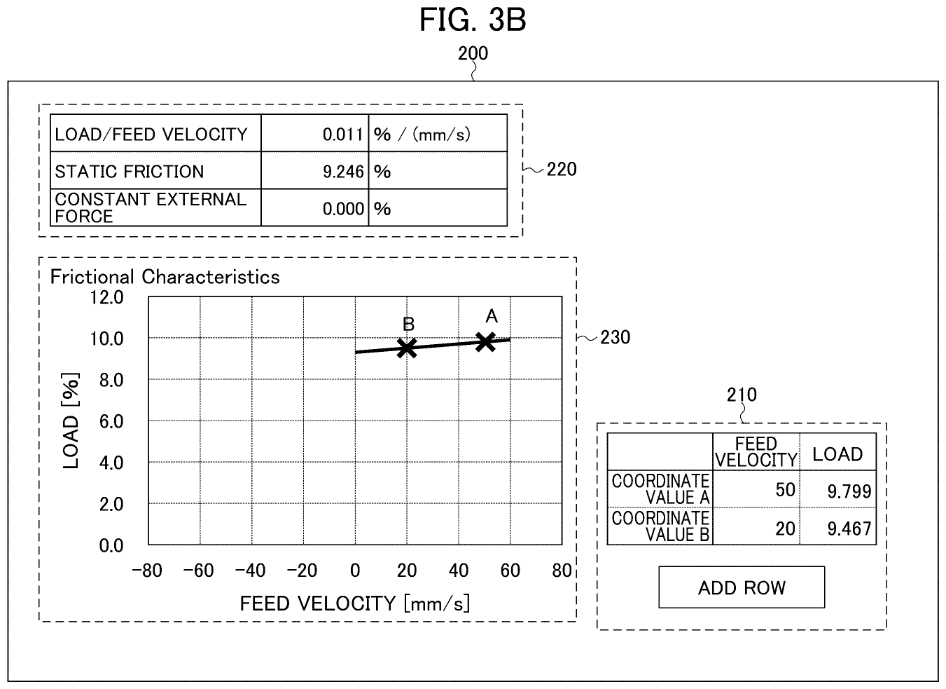

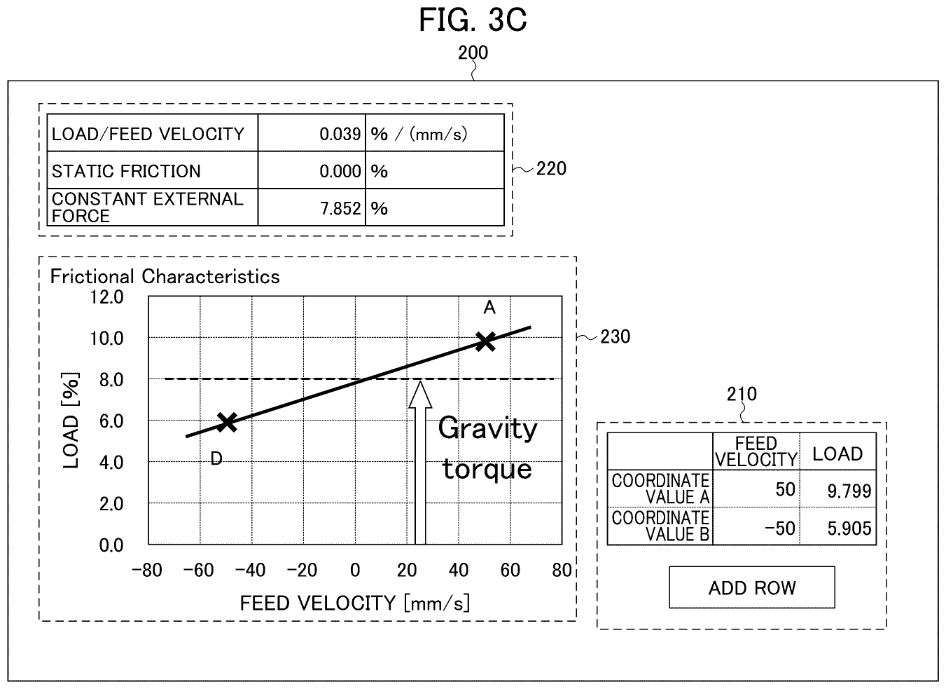

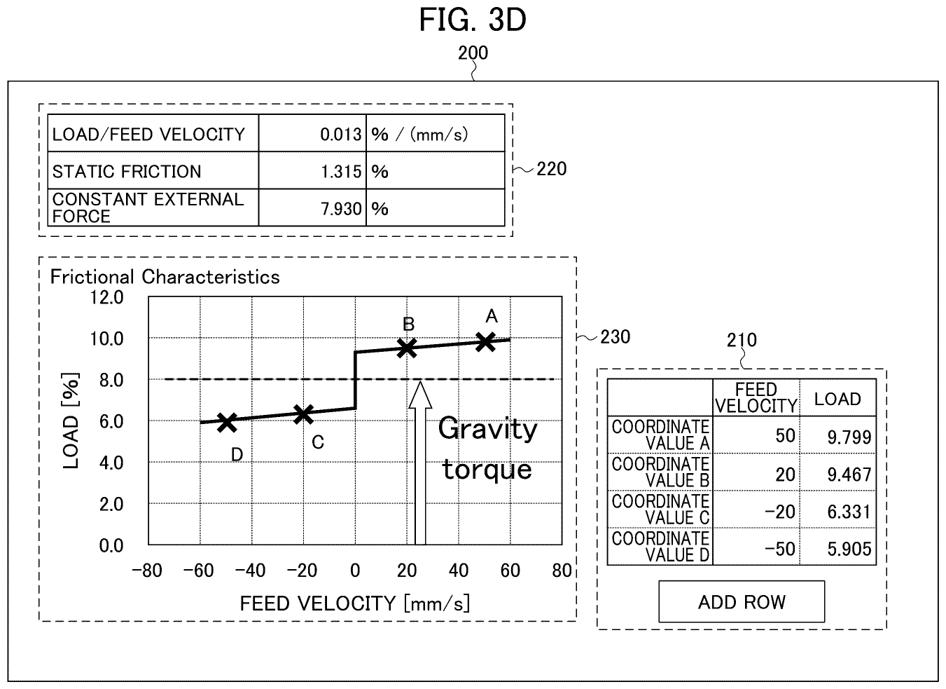

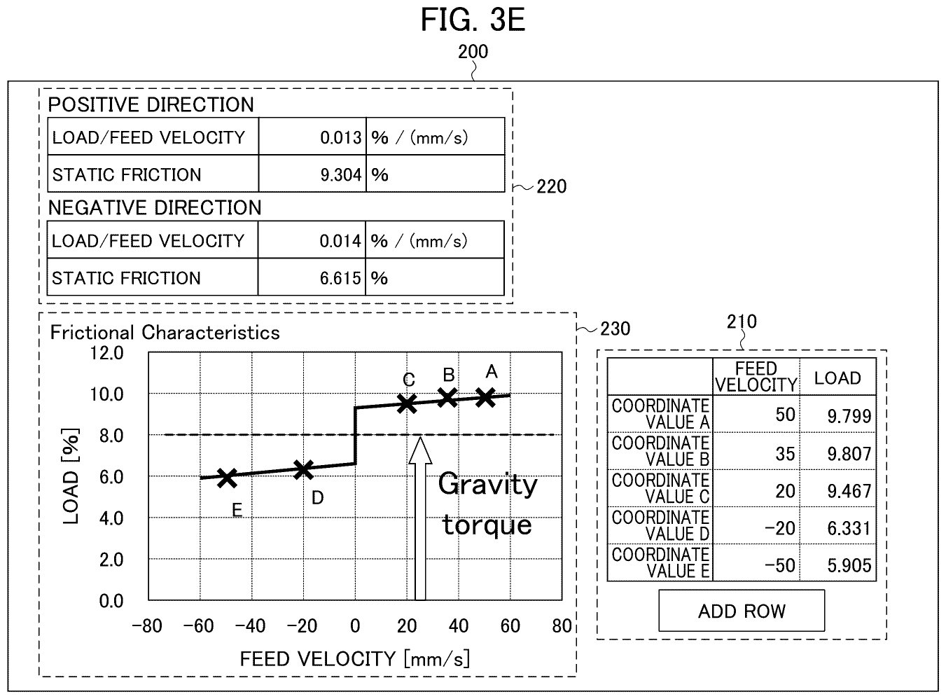

Specifically, when the model determination unit 1101 determines the type of friction model with one data point, the coefficient calculation unit 1102 calculates f/v from the single point of load and velocity data acquired from the storage device 20 to calculate the coefficient a. The friction model generation unit 110 displays the results related to the generated friction model on the display unit 12 in a screen 200 illustrated in FIG. 3A.

The screen 200 illustrated in FIG. 3A includes a data display area 210 that displays the load and velocity data acquired from the storage device 20, a coefficient display area 220 that displays the coefficient a calculated by the coefficient calculation unit 1102, and a model display area 230 that displays the generated friction model. Specifically, in the data display area 210, for example, the feed velocity of 50 mm/s and the load (TCMD) of 9.799% are displayed as the single point of load and velocity data. The data display area 210 may also include a button labeled “Add Row” for adding more load and velocity data. The coefficient display area 220 displays the load/feed velocity value of 0.196%/(mm/s) as the coefficient a. In the case where the number of data points is one, there is no static friction (intercept b·sgn(v)) or constant external force (intercept g), which are therefore displayed as “0”. The model display area 230 displays the generated friction model.

When the model determination unit 1101 determines the type of friction model with two (identical) data points, the coefficient calculation unit 1102 calculates the coefficient a and the intercept b·sgn(v) from the two data points for the load and velocity acquired from the storage device 20. The friction model generation unit 110 displays the results related to the generated friction model on the display unit 12 in a screen 200 illustrated in FIG. 3B.

In the screen 200 illustrated in FIG. 3B, for example, the data display area 210 illustrates two data points for the load and velocity where the moving directions of the feed shaft of the machine tool (not illustrated) are the same, with the feed velocities of 50 mm/s and 20 mm/s, and the load values of 9.799% and 9.467%, respectively. The coefficient display area 220 of the screen 200 displays the load/feed velocity value of 0.011%/(mm/s) as the coefficient a, and the static friction (intercept b·sgn(v)) value of 9.246%. In the case where the number of data points is two (identical), there is no constant external force (intercept g), which is therefore displayed as “0”. The model display area 230 of the screen 200 displays the generated friction model.

When the model determination unit 1101 determines the type of friction model with two (opposite) data points, the coefficient calculation unit 1102 calculates the coefficient a and the intercept g from the two data points for the load and velocity acquired from the storage device 20. The friction model generation unit 110 displays the results related to the generated friction model on the display unit 12 in a screen 200 illustrated in FIG. 3C.

In the screen 200 illustrated in FIG. 3C, for example, the data display area 210 displays two data points for the load and velocity where the moving directions of the feed shaft of the machine tool (not illustrated) are opposite, with the feed velocities of 50 mm/s and −50 mm/s, and the load values of 9.799% and 5.905%, respectively. The coefficient display area 220 of the screen 200 displays the load/feed velocity value of 0.039%/(mm/s) as the coefficient a, and the constant external force (intercept g) value of 7.852%. In the case where the number of data points is two (opposite), there is no static friction (intercept b·sgn(v)), which is therefore displayed as “0”. The model display area 230 of the screen 200 displays the generated friction model.

When the model determination unit 1101 determines the type of friction model with four data points, the coefficient calculation unit 1102 calculates the coefficients a₁, a₂ and the intercepts b₁, b₂ from the four points of load and velocity data acquired from the storage device 20. The friction model generation unit 110 displays the results related to the generated friction model on the display unit 12 in a screen 200 illustrated in FIG. 3D.

In the screen 200 illustrated in FIG. 3D, for example, the data display area 210 illustrates four points of load and velocity data where the moving directions of the feed shaft of the machine tool (not illustrated) are opposite, with the feed velocities of 50 mm/s, 20 mm/s, −20 mm/s, and −50 mm/s, and the load values of 9.799%, 9.467%, 6.331%, and 5.905%. The coefficient display area 220 of the screen 200 displays the load/feed velocity value of 0.013%/(mm/s) as the coefficient a (=(a₁+a₂)/2), the static friction (intercept b·sgn(v)) value of 1.315%, and the constant external force (load f=(b₁+b₂)/2) value of 7.930%. The model display area 230 of the screen 200 displays the generated friction model.

When the model determination unit 1101 determines the type of friction model with four or more data points, the coefficient calculation unit 1102 calculates the coefficients a₁, a₂ and the intercepts b₁, b₂ from the four points of load and velocity data, as follows. First, the coefficient calculation unit 1102 calculates the coefficient a₁=(f_{A}−f_{B})/(v_{A}−v_{B}) and the intercept b₁=f_{A}−a₁·v_{A} using data A (v_{A}, f_{A}) and data B (v_{B}, f_{B}) in the screen 200 illustrated in FIG. 3D. The coefficient calculation unit 1102 calculates the intermediate coefficient a₂=(f_{C}−f_{D})/(v_{C}−v_{D}) and the intercept b₂=f_{C}−a₂·v_{C} using data C (v_{C}, f_{C}) and data D (v_{D}, f_{D}). Then, the coefficient calculation unit 1102 uses the calculated intercepts b₁ and b₂ to calculate the load f=(b₁+b₂)/2 at the velocity v being “0”, as the constant external force.

In the case where the number of data points for load and velocity data is five, when the model determination unit 1101 determines the type of friction model with four or more data points, the coefficient calculation unit 1102 calculates the coefficients a₁, a₂ and the intercepts b₁, b₂ from the five points of load and velocity data acquired from the storage device 20.

Specifically, as illustrated in FIG. 3E, for example, in the case where the number of data points for load and velocity data is five, i.e., there are three data points on the positive side of the velocity v, the coefficient calculation unit 1102 applies the least-squares method or another method to the three points of load and velocity data on the positive side of the velocity v to calculate the coefficient a₁ and the intercept b₁. That is, the coefficient calculation unit 1102 calculates the coefficient a₁=Σ_{i=1,N}(vᵢ−<v>)·(fᵢ−<f>)/Σ_{i=1,N}(vᵢ−<v>)², and the intercept b₁=<f>−a₁·<v>. Here, N represents the number of data points on the positive side of the velocity v. [symbol] v [symbol] and [symbol] f [symbol] represent the averages of N data points for the velocity v and the load f, respectively, on the positive side.

The coefficient calculation unit 1102 calculates the coefficient a₂ and the intercept b₂ for the two data points for the load and velocity on the negative side of the velocity V, in the same manner as described for the case of FIG. 3D.

The friction model generation unit 110 displays the results related to the generated friction model on the display unit 12 in a screen 200 illustrated in FIG. 3E. Although FIG. 3E illustrates three points of load and velocity data on the positive side of the velocity v, in the case where there are three or more points of load and velocity data on the negative side of the velocity v, the coefficient calculation unit 1102 also calculates the coefficient a₂ and the intercept b₂ in the same manner.

The data display area 210 of the screen 200 illustrated in FIG. 3E displays five points of load and velocity data for the feed shaft of the machine tool (not illustrated), with the feed velocities of 50 mm/s, 35 mm/s, 20 mm/s, −20 mm/s, and −50 mm/s, and the load values of 9.799%, 9.807%, 9.467%, 6.331%, and 5.905%, respectively. The coefficient display area 220 of the screen 200 displays the load/feed velocity value of 0.011%/(mm/s) as the coefficient a₁ in the positive direction (positive side), and the static friction (intercept b₂) value of 9.304%, and displays the load/feed velocity value of 0.014%/(mm/s) as the coefficient a₂ in the negative direction (negative side), and the static friction (intercept b₂) value of 6.615%. The model display area 230 of the screen 200 displays the generated friction model.

The simulation execution unit 111 simulates and reproduces the behavior of the machine tool (not illustrated) using the friction model generated by the friction model generation unit 110.

Specifically, the simulation execution unit 111 uses the friction model generated by the friction model generation unit 110 and well-known simulation methods to simulate the position and behavior of each shaft of the machine tool (not illustrated), based on input of the command positions generated by the machining program.

Thus, the machining simulation device 10, by using the friction model with the determined type and coefficients, can output the load in response to velocity inputs and simulate and reproduce the friction in the position and behavior of each shaft of the machine tool (not illustrated).

### Simulation Processing of Machining Simulation Device

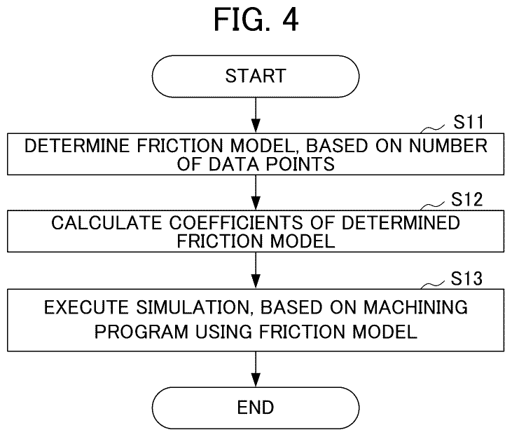

Next, the flow of the simulation processing of the machining simulation device 10 will be described with reference to FIG. 4.

FIG. 4 is a flowchart illustrating the simulation processing of the machining simulation device 10.

In Step S11, the model determination unit 1101 determines the friction model, based on the number of data points for load and velocity data of the machine tool (not illustrated), as acquired from the storage device 20.

In Step S12, the coefficient a (or coefficients a₁, a₂, intercepts b₁, b₂, intercept b·sgn(v), and intercept g) of the friction model is calculated based on the load and velocity data acquired from the storage device 20 and the friction model determined in Step S11.

In Step S13, the simulation execution unit 111 simulates the position and behavior of each shaft of the machine tool (not illustrated), based on the machining program, using the friction model generated in Step S12.

As described above, the machining simulation device 10 according to the present embodiment can easily generate a friction model for a machine tool without requiring trial operation of the machine tool or specialized knowledge. In other words, the user can consider friction as part of the transfer characteristics of the machine tool even without specialized knowledge.

Since the machining simulation device 10 can generate a friction model with at least one data point, a trial operation of the machine tool (not illustrated) solely for the purpose of generating the friction model is not required.

### Modification Example 1

In the embodiment described, although the machining simulation device 10 and the storage device 20 are separate devices, this is not limiting. For example, the storage device 20 may be included as part of the machining simulation device 10.

### Modification Example 2

For example, in the above embodiment, the friction model for four or more data points is defined as illustrated in FIG. 2A; however, this is not limiting. For example, the friction model for four or more data points may also be a linear function consisting of viscous friction, static friction, and a constant effect, expressed as f=a·v+b·sgn(v)+g. In this case, the coefficients a, the intercept b·sgn(v), and intercept g can be derived using the coefficients a₁, a₂ and the intercepts b₁, b₂ of the friction model illustrated in FIG. 2A, as follows: a=(a₁+a₂)/2, b=(b₁−b₂)/2, and g=(b₁+b₂)/2.

The functions included in the machining simulation device 10 in one embodiment can be implemented by hardware, software, or a combination of both. Implementation by software means implementation by a computer that reads and executes a program(s).

The program(s) can be stored on and provided to a computer using various types of non-transitory computer-readable media. Non-transitory computer-readable media include various types of tangible storage media. Examples of non-transitory computer-readable media include magnetic storage media (e.g., flexible disks, magnetic tapes, hard disk drives), magneto-optical storage media (e.g., magneto-optical disks), CD-ROM (Read-Only Memory), CD-R, CD-R/W, and semiconductor memories (e.g., mask ROM, PROM (Programmable ROM), EPROM (Erasable PROM), flash ROM, RAM). The program(s) may also be provided to the computer via various types of transitory computer-readable media. Examples of transitory computer-readable media include electrical signals, optical signals, and electromagnetic waves. Transitory computer-readable media can provide the program to the computer via wired communication paths such as electrical cables and optical fibers or via wireless communication paths.

The steps that describe the program recorded on the storage medium include processing executed sequentially in a time series, as well as processing executed in parallel or individually, which may not necessarily follow a time sequence. The steps describing the program may also be implemented through cloud computing.

Although the present disclosure has been described in detail, the present disclosure is not limited to the individual embodiments mentioned above. These embodiments may undergo various modifications such as additions, substitutions, changes, or partial deletions without departing from the spirit of the present disclosure, or within the scope of the present disclosure as derived from the claims or the equivalents thereof. The embodiments may also be implemented in combination. For example, in the above-described embodiments, the order of operations and the sequence of processing are merely examples and are not limiting. The same applies to cases where numerical values or formulas are used in the description of the embodiments.

The following additional notes are disclosed in relation to the above embodiments and modification examples:

### (Additional Note 1)

The machining simulation device (10) includes: a friction model generation unit (110) configured to generate a friction model for a machine tool; and a simulation execution unit (111) configured to simulate and reproduce the behavior of the machine tool using the friction model. The friction model generation unit (110) includes: a model determination unit (1101) configured to determine the type of friction model, based on the number of data points for torque and velocity; and a coefficient calculation unit (1102) configured to calculate the coefficients of the friction model, based on the determined type of friction model and the torque and velocity data for the number of data points. The friction model generation unit (110) reflects the generated friction model in the simulation execution unit (111).

### (Additional Note 2)

In the machining simulation device (10) of Additional Note 1, the friction model includes a constant effect in a specific direction.

### (Additional Note 3)

In the machining simulation device (10) of Additional Note 2, the model determination unit (1101) determines: a type of friction model for viscous friction, in a case where the number of data points is one; a type of friction model for viscous friction and static friction, in a case where the number of data points is two and the velocities of the two data points are in the same direction of movement; a type of friction model for viscous friction and constant effect, in a case where the number of data points is two and the velocities of the two data points are in opposite directions of movement; and a type of friction model for viscous friction, static friction, and constant effect, in a case where the number of data points is four.

### (Additional Note 4)

The machining simulation method is a machining simulation method that causes a computer to function as a machining simulation device (10), in which the method includes: a friction model generating step of generating a friction model for a machine tool; and a simulation executing step of simulating and reproducing the behavior of the machine tool using the friction model. The friction model generating step includes: a model determining step of determining the type of friction model, based on the number of data points for torque and velocity; and a coefficient calculating step of calculating the coefficients of the friction model, based on the determined type of friction model and the torque and velocity data for the number of data points. The friction model generating step reflects the generated friction model in the simulation executing step.

### (Additional Note 5)

In the machining simulation method of Additional Note 4, the friction model includes a constant effect in a specific direction.

### (Additional Note 6)

In the machining simulation method of Additional Note 5, the model determining step determines: a type of friction model for viscous friction, in a case where the number of data points is one; a type of friction model for viscous friction and static friction, in a case where the number of data points is two and the velocities of the two data points are in the same direction of movement; a type of friction model for viscous friction and constant effect, in a case where the number of data points is two and the velocities of the two data points are in opposite directions of movement; and a type of friction model for viscous friction, static friction, and constant effect, in a case where the number of data points is four.

### EXPLANATION OF REFERENCE NUMERALS

1: machining simulation system
10: machining simulation device
11: control unit
110: friction model generation unit
1101: model determination unit
1102: coefficient calculation unit
111: simulation execution unit
12: display unit
13: input unit
20: storage device

1. A machining simulation device, comprising:
a friction model generation unit configured to generate a friction model for a machine tool; and
a simulation execution unit configured to simulate and reproduce behavior of the machine tool using the friction model,
wherein the friction model generation unit includes:
a model determination unit configured to determine a type of the friction model, based on a number of data points for torque and velocity; and
a coefficient calculation unit configured to calculate coefficients of the friction model, based on the determined type of the friction model and torque and velocity data for the number of data points, and
wherein the friction model generation unit reflects the generated friction model in the simulation execution unit.

2. The machining simulation device according to claim 1, wherein the friction model includes a constant effect in a specific direction.

3. The machining simulation device according to claim 2, wherein the model determination unit determines: a type of friction model for viscous friction, in a case where a number of data points is one; a type of friction model for the viscous friction and static friction, in a case where the number of data points is two and velocities of the two data points are in a same direction of movement; a type of friction model for the viscous friction and the constant effect, in a case where the number of data points is two and the velocities of the two data points are in opposite directions of movement; and a type of friction model for the viscous friction, the static friction, and the constant effect, in a case where the number of data points is four.

4. A machining simulation method that causes a computer to function as a machining simulation device, the method comprising:
a friction model generating step of generating a friction model for a machine tool; and
a simulation executing step of simulating and reproducing behavior of the machine tool using the friction model,
wherein the friction model generating step includes:
a model determining step of determining a type of the friction model, based on a number of data points for torque and velocity; and
a coefficient calculating step of calculating coefficients of the friction model, based on the determined type of friction model and the torque and velocity data for the number of data points, and
wherein the friction model generating step reflects the generated friction model in the simulation executing step.

5. The machining simulation method according to claim 4, wherein the friction model includes a constant effect in a specific direction.

6. The machining simulation method according to claim 5, wherein the model determination step determines: a type of friction model for viscous friction, in a case where a number of data points is one; a type of friction model for the viscous friction and static friction, in a case where the number of data points is two and velocities of the two data points are in a same direction of movement; a type of friction model for the viscous friction and the constant effect, in a case where the number of data points is two and the velocities of the two data points are in opposite directions of movement; and a type of friction model for the viscous friction, the static friction, and the constant effect, in a case where the number of data points is four.
